(19) United States
(12) Patent Application Publication
(10) Pub. No.: US 2026/0263951 A1
(43) Pub. Date: Sep. 10, 2026

(54) CONTROLLER

(71) Applicant: NINTENDO CO., LTD., Kyoto-shi (JP)

(72) Inventor: Kenichi IKEDA, Kyoto-shi (JP)

(21) Appl. No.: 19/659,835

(22) Filed: Apr. 27, 2026

Related U.S. Application Data
(63) Continuation of application No. PCT/JP2023/039603, filed on Nov. 2, 2023.

(51) Int. Cl. A63F 13/92; H01H 13/14

(52) U.S. Cl. CPC A63F 13/92; H01H 13/14

(57) ABSTRACT

The controller includes a housing which has an opening, a first bearing which is provided in an interior of the housing, a first operation button which has a first operation surface exposed from the opening, and a first shaft which is supported by the first bearing so as to be rotatable in a first rotation direction about an axis and movable in a first linear direction, and a first switch which is pressed by the first operation button when the first operation button is rotated in the first rotation direction by rotation of the first shaft, and when the first operation button is moved in the first linear direction by linear movement of the first shaft. The first shaft is arranged so as to be positioned inward from both ends of the first operation surface. The first shaft abuts against the first bearing when the first shaft attempts to rotate in a second rotation direction from a natural state, thereby restricting the first operation button from rotating more than a predetermined angle in the second rotation direction.

### CROSS-REFERENCE TO RELATED APPLICATION

This application is a continuation application of International Patent Application No. PCT/JP2023/039603 filed on Nov. 2, 2023, the entire contents of which are incorporated herein by reference.

### TECHNICAL FIELD

The present disclosure relates to a controller.

### BACKGROUND AND SUMMARY

Conventionally, in controllers, it is known that rotating an operation button causes it to press against a switch provided in a housing.

In such a controller, a rotating part of the operation button may be positioned inward from both ends of an operation surface of the operation button, whereby the operation button can rotate in both the clockwise and counterclockwise directions.

However, depending on the positional relationship between the operation surface, the rotating part, and the switch, the operability of the operation button may deteriorate when the operation button is rotated in a specific rotation direction.

Certain examples of the present disclosure are as follows.
(1) A controller comprising: a housing which has an opening; a first bearing which is provided in an interior of the housing; a first operation button which has a first operation surface exposed from the opening, and a first shaft which is supported by the first bearing so as to be rotatable in a first rotation direction about an axis and movable in a first linear direction; and a first switch which is pressed by the first operation button when the first operation button is rotated in the first rotation direction by rotation of the first shaft, and when the first operation button is moved in the first linear direction by linear movement of the first shaft, wherein when the first operation button is viewed from an axial direction of the first shaft, the first shaft is arranged so as to be positioned inward from both ends of the first operation surface, and the first shaft is configured to abut against the first bearing when the first shaft attempts to rotate in a second rotation direction opposite to the first rotation direction from a natural state in which the first operation button is not operated, thereby restricting the first operation button from rotating more than a predetermined angle in the second rotation direction.
(2) The controller described in above (1), wherein the first bearing has two wall surfaces which extend in a direction away from the first operation surface and face each other, and when the first shaft and the first bearing are viewed from the axial direction, a linear distance connecting two predetermined points on an outer edge of the first shaft is greater than a distance between the two wall surfaces.
(3) The controller described in above (1) or (2), wherein the first bearing has two wall surfaces which extend in a direction away from the first operation surface and face each other, and the first shaft has a first straight part which extends parallel to one of the two wall surfaces in the natural state, and a second straight part which extends parallel to the other of the two wall surfaces in the natural state.
(4) The controller described in above (3), wherein the first shaft has a first curved part which extends from the first straight part, and a second curved part which extends from the second straight part, the first curved part extends in a direction including a direction which approaches the second straight part and a direction which approaches the first operation surface when the first operation button and the first bearing are viewed from the axial direction, and the second curved part extends in a direction including a direction which approaches the first straight part and a direction away from the first operation surface when the first operation button and the first bearing are viewed from the axial direction, and a linear distance connecting a first point on the first curved part and a second point on the second curved part is equal to or less than a distance between the two wall surfaces.
(5) The controller described in above (4), wherein the first curved part and the second curved part are arcs when viewed from the axial direction.
(6) The controller described in any one of above (1) to (5), further comprising: a second bearing which is provided in an interior of the housing; a second operation button which has a second operation surface exposed from the opening, and a second shaft which is supported by the second bearing so as to be rotatable in the second rotation direction and movable in the first linear direction; and a second switch which is pressed by the second operation button when the second operation button is rotated in the second rotation direction by rotation of the second shaft, and when the second operation button is moved in the first linear direction by linear movement of the second shaft, wherein when the second operation button is viewed in an axial direction of the second shaft, the second shaft is arranged so as to be positioned inward from both ends of the second operation surface, the second shaft is configured to abut against the second bearing when the second shaft attempts to rotate in the first rotation direction from a natural state in which the second operation button is not operated, thereby restricting the second operation button from rotating more than the predetermined angle in the first rotation direction, the housing has: a primary surface where a direction input part operated by a user is provided; an upper surface positioned upward as viewed from the user in a state in which the housing is held by the user such that the primary surface faces the user; a left surface positioned leftward as viewed from the user in the state; and a right surface positioned on a side opposite the left surface; the first operation button is arranged in an area at the upper surface which is closer to the left surface than to the right surface and to which a left index finger or left middle finger of the user extends when the housing is held by the user, the second operation button is arranged in an area at the upper surface which is closer to the right surface than the left surface and to which a right index finger or right middle finger of the user extends when the housing is held by the user, and the first rotation direction is counterclockwise as viewed from the user in the state, and the second rotation direction is clockwise as viewed from the user in the state.
(7) The controller described in above (6), further comprising: a third operation button arranged in an area at the upper surface which is more to the right surface side than the first operation button and to which a left index finger or left middle finger of the user extends when the housing is held by the user; and a fourth operation button arranged in an area at the upper surface which is more to the left surface side than the second operation button and to which a right index finger or right middle finger of the user extends when the housing is held by the user.

### BRIEF DESCRIPTION OF DRAWINGS

Embodiments of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a front view of a controller according to a first embodiment of the present disclosure.

FIG. 2 is a top view of the controller according to the first embodiment of the present disclosure.

FIG. 3 is a partial cross-sectional view of the controller taken along line A-A of FIG. 2.

FIG. 4 is an enlarged view of a first shaft and a first bearing of FIG. 3.

FIG. 5 is a partial cross-sectional view of the controller taken along line B-B of FIG. 2.

FIG. 6 is a front view of a controller according to a second embodiment of the present disclosure.

FIG. 7 is a top view of the controller according to the second embodiment of the present disclosure.

FIG. 8 is a partial cross-sectional view of the controller taken along line C-C of FIG. 7.

FIG. 9 shows a modification example of a first shaft of a first operation button.

### DETAILED DESCRIPTION

The embodiments of the present disclosure will be described in detail below with reference to the drawings. Note that in the following description, similar constituent elements have been assigned the same reference signs.

### First Embodiment

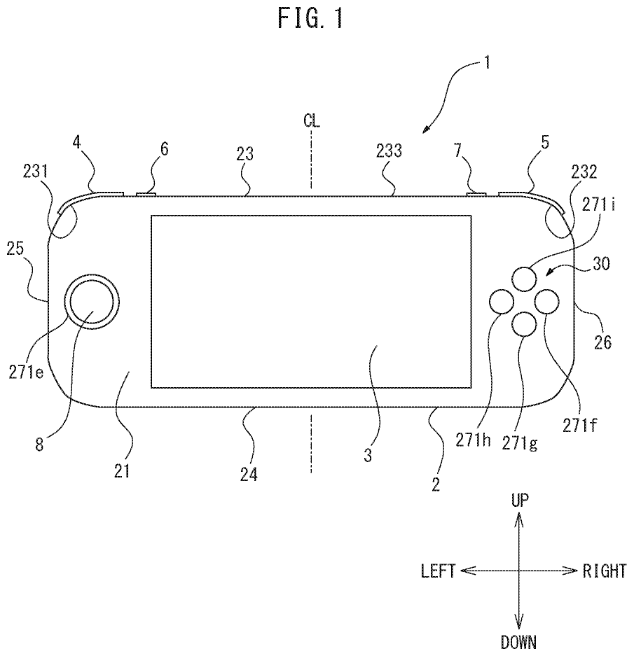

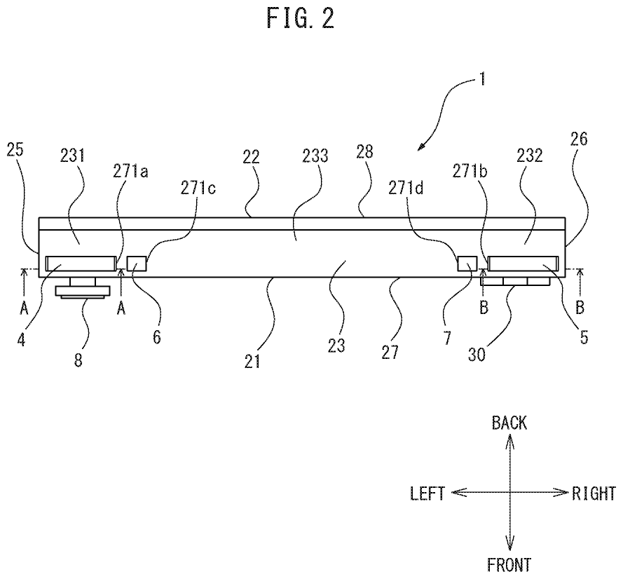

Initially, a first embodiment of the present disclosure will be described with reference to FIGS. 1 to 5. FIG. 1 is a front view of a controller 1 according to the first embodiment of the present disclosure, and FIG. 2 is a top view of the controller 1 according to the first embodiment of the present disclosure.

The controller 1 has a substantially rectangular parallelepiped shape and is held by the user. The user holds the controller 1 in the orientation shown in FIG. 1, and FIG. 1 shows the controller 1 on the side facing the user. As shown in FIG. 1, the controller 1 includes a housing 2, a display 3, and operation members. In the present embodiment, the controller 1 functions as a portable game console and is powered by, for example, a built-in battery.

The housing 2 has a substantially rectangular parallelepiped shape and forms the outer surface of the controller 1. The housing 2 has a primary surface 21, a back surface 22 positioned on the side opposite the primary surface 21, and a side surface connecting the primary surface 21 and the back surface 22. The display 3 and a direction input part 8, which will be described later, are provided in the primary surface 21 of the housing 2, and the primary surface 21 faces the user when the controller 1 is used by the user. In the present description, the direction of the controller 1 is defined in a state in which the housing 2 is held by the user such that the primary surface 21 faces the user (hereinafter referred to as the “held state”).

The side surface of the housing 2 has an upper surface 23, a lower surface 24, a left surface 25, and a right surface 26. The upper surface 23 is positioned upwards as viewed by the user in the held state, and the lower surface 24 is positioned on the side opposite the upper surface 23 and is positioned downward as viewed by the user in the held state. The left surface 25 is positioned leftward as viewed by the user in the held state, and the right surface 26 is positioned on the side opposite the left surface 25 and is positioned rightward as viewed by the user in the held state. In the present embodiment, the length of the housing 2 in the left-right direction is greater than the length of the housing 2 in the up-down direction, and the controller 1 has a horizontally elongated shape.

In the present embodiment, the upper surface 23 of the housing 2 has an upper left corner 231, an upper right corner 232, and a horizontal part 233 between the upper left corner 231 and the upper right corner 232. The upper left corner 231 has a round shape and is connected to the left surface 25. The upper right corner 232 has a round shape and is connected to the right surface 26. The horizontal part 233 is a flat surface and is smoothly connected to the upper left corner 231 and the upper right corner 232. The upper left corner 231 and the upper right corner 232 may each have a chamfered shape.

In the present description, “up” means the direction from the lower surface to the upper surface, “down” means the direction from the upper surface to the lower surface, “left” means the direction from the right surface to the left surface, “right” means the direction from the left surface to the right surface, “front” means the direction from the back surface to the primary surface, and “back” means the direction from the primary surface to the back surface. Therefore, for example, the terms upper side, lower side, right side, left side, front side, and back side can be interpreted as the upper surface side, the lower surface side, the right surface side, the left surface side, the primary surface side, and the back surface side, respectively. Also, the terms up-down direction, left-right direction, and front-back direction can be read as the up-down direction between the upper surface and the lower surface, the left-right direction between the left surface and the right surface, and the front-back direction between the primary surface and the back surface, respectively. Furthermore, the terms upward, downward, forward, and rearward can be interpreted as the direction towards the upper surface, the direction towards the lower surface, the direction towards the primary surface, and the direction towards the back surface, respectively.

The housing 2 includes a first housing 27 and a second housing 28, and is formed by combining the first housing 27 and the second housing 28. As shown in FIG. 2, the first housing 27 is arranged on the front side of the controller 1, and the second housing 28 is arranged on the back side of the controller 1. The first housing 27 and the second housing 28 define the interior space of the housing 2 when the first housing 27 and the second housing 28 are combined. The first housing 27 and the second housing 28 are each made of resin, metal, etc., and are formed by injection molding, die casting, or the like.

The display 3 is provided in the primary surface 21 of the housing 2 such that the display surface thereof is visible to the user, and displays visual information (text, images, etc.). In the present embodiment, the display 3 is arranged in the central area in the left-right direction of the controller 1. The display 3 is, for example, a liquid crystal display (LCD), an organic EL display, or the like. Note that the display 3 may be a touch panel display.

In the controller 1, the operation members are provided such that at least a part of each member is exposed to the outside of the housing 2, and are operated by the user. In the present embodiment, as shown in FIG. 2, the controller 1 includes a first operation button 4, a second operation button 5, a third operation button 6, and a fourth operation button 7 as operation members provided at the upper surface 23 of the housing 2. For example, the third operation button 6 is one of a plus button and a minus button, and the fourth operation button 7 is the other of the plus button and the minus button.

The first operation button 4 and the third operation button 6 are arranged in an area at the upper surface 23 closer to the left surface 25 than to the right surface 26, that is, in an area to the left of a left-right center line CL of the controller 1. The left-right center line CL of the controller 1 refers to the line which bisects the controller 1 in the left-right direction.

The first operation button 4 and the third operation button 6 are arranged adjacent to each other in the left-right direction, and the third operation button 6 is arranged in an area to the right of the first operation button 4. In the present embodiment, the first operation button 4 is arranged in the upper left corner 231 and horizontal part 233 of the upper surface 23, and the third operation button 6 is arranged in the horizontal part 233 of the upper surface 23. The first operation button 4 and the third operation button 6 are each arranged in an area to which the left index finger or left middle finger of the user extends when the housing 2 is held by the user (for example, when the left hand of the user is placed on the left surface 25 of the housing 2), and are operated by the left index finger or left middle finger of the user.

On the other hand, the second operation button 5 and the fourth operation button 7 are arranged in an area at the upper surface 23 closer to the right surface 26 than to the left surface 25, that is, in an area to the right of the left-right center line CL of the controller 1. The second operation button 5 and the fourth operation button 7 are arranged adjacent to each other in the left-right direction, and the fourth operation button 7 is arranged in an area to the left of the second operation button 5. In the present embodiment, the second operation button 5 is arranged in the upper right corner 232 and horizontal part 233 of the upper surface 23, and the fourth operation button 7 is arranged in the horizontal part 233 of the upper surface 23. The second operation button 5 and the fourth operation button 7 are each arranged in an area to which the right index finger or right middle finger of the user extends when the housing 2 is held by the user (for example, when the right hand of the user is placed on the right surface 26 of the housing 2), and are operated by the right index finger or right middle finger of the user.

Furthermore, as shown in FIG. 1, the controller 1 includes the direction input part 8 and a group of buttons 30 as operation members provided in the primary surface 21 of the housing 2. The direction input part 8 is operated by the user when the user inputs a direction, and in the present embodiment, is an analog stick. The direction input part 8 may be a directional pad or the like. The group of buttons 30 consists of four buttons, for example, an A button, a B button, an X button, and a Y button. The direction input part 8 is arranged in an area to the left of the left-right center line CL of the controller 1, and the group of buttons 30 is arranged in an area to the right of the left-right center line CL of the controller 1. The operation members are made of resin, metal, etc., and are formed by injection molding, die casting, or the like.

Furthermore, as shown in FIGS. 1 and 2, the first housing 27 has openings 271a to 271d through which the operation members provided at the upper surface 23 of the housing 2 can pass, and openings 271e to 271i through which the operation members provided in the primary surface 21 of the housing 2 can pass. The openings 271a to 271d open at the upper surface 23 of the housing 2, and the openings 271e to 271i open at the primary surface 21 of the housing 2.

Note that the configuration and arrangement of the operation members shown in FIGS. 1 and 2 are merely exemplary, and some operation members may be omitted or other operation members may be added. For example, the controller 1 may further includes an additional stick member separate from the direction input part 8, a capture button for capturing the image displayed on the display 3, a home button for displaying a home menu, etc., as operation members provided in the primary surface 21 of the housing 2. Further, the display 3 may be omitted.

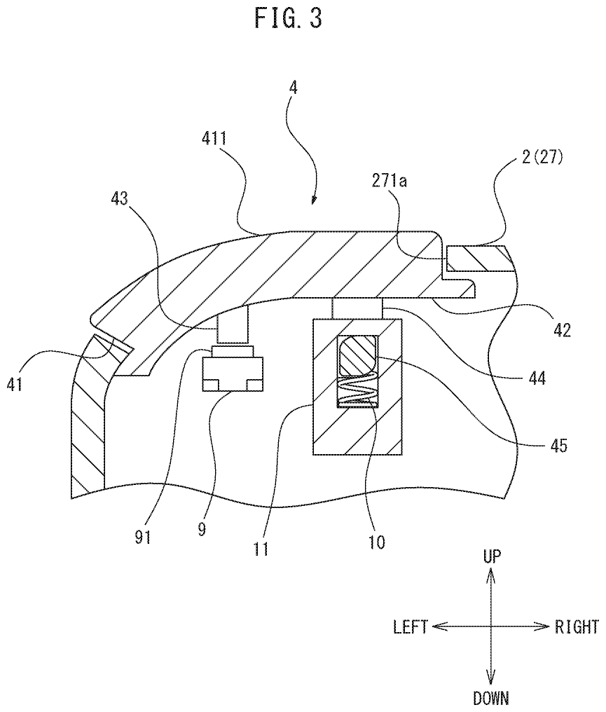

FIG. 3 is a partial cross-sectional view of the controller 1 taken along line A-A of FIG. 2. As shown in FIG. 3, the controller 1 has a first switch 9 and a first spring 10 as internal components. The first switch 9 and first spring 10 are arranged in an area closer to the left surface 25 than to the right surface 26, and the first switch 9 is arranged to the left of the first spring 10. The first switch 9 is arranged directly below the first operation button 4 in the interior space of the housing 2 and is pressed by the first operation button 4. The first spring 10 is arranged directly below the first operation button 4 in the interior space of the housing 2 and biases the first operation button 4 upward.

As shown in FIG. 3, the first operation button 4 has a first keycap part 41, a first foundation part 42, a first protrusion 43, a first shaft base part 44, and a first shaft 45. The first keycap part 41, the first foundation part 42, the first protrusion 43, the first shaft base part 44, and the first shaft 45 are integrally molded by injection molding, die casting, or the like.

The first keycap part 41 is positioned at the top of the first operation button 4 and is partially exposed from the housing 2 through the opening 271a of the housing 2. As shown in FIG. 3, the first keycap part 41 has a first operation surface 411 that is exposed from the opening 271a of the housing 2. The first operation surface 411 is positioned outside the upper surface 23 and extends parallel to the upper surface 23 (horizontal part 233 and upper left corner 231). The first operation surface 411 is contacted by the finger (left index finger or left middle finger) of the user when the user operates the first operation button 4.

The first foundation part 42 is positioned below the first keycap part 41, and the first keycap part 41 protrudes outward from the upper surface of the first foundation part 42. The first foundation part 42 is larger than the opening 271a of the housing 2 and is arranged in the interior space of the housing 2. The left end of the first foundation part 42 abuts against the housing 2 in a natural state in which the first operation button 4 is not operated (hereinafter referred to as the “natural state of the first operation button 4”).

The first protrusion 43 has a substantially cylindrical shape and protrudes downward from the lower surface of the first foundation part 42. The first protrusion 43 faces the first switch 9 in the interior space of the housing 2. The first switch 9 has a first pressed part 91 which extends in the direction approaching the first operation surface 411 and the first protrusion 43. The first protrusion 43 presses the first pressed part 91 of the first switch 9 when the first operation button 4 is operated. Note that the first protrusion 43 may be omitted if the first operation button 4 is formed such that the first pressed part 91 is pressed by the first foundation part 42, etc.

The first shaft base part 44 is arranged to the right of the first protrusion 43 in the interior space of the housing 2 and protrudes downward from the lower surface of the first foundation part 42. The first shaft 45 protrudes forward from the front surface of the first shaft base part 44. The first shaft 45 is connected to the first foundation part 42 and the first keycap part 41 via the first shaft base part 44.

The controller 1 includes a first bearing 11 provided in the interior of the housing 2. The first bearing 11 is arranged in an area closer to the left surface 25 than to the right surface 26, and is arranged to the right of the first switch 9. In the present embodiment, the first bearing 11 is formed in the first housing 27 and protrudes rearward from the back surface (back) of the first housing 27.

In the present description, the phrase “a second element is provided in a first element” includes an aspect in which the second element is formed in the first element, that is, an aspect in which the second element is a part of the first element, and an aspect in which the second element, formed separately from the first element, is attached to the first element. Therefore, in the present embodiment, the first bearing 11 is formed in the back surface of the first housing 27, but the first bearing 11 may be separate from the first housing 27 and be attached to the back surface of the first housing 27 by fasteners (for example, screws), adhesive members (for example, adhesive, adhesive tape, etc.).

The first spring 10 and the first shaft 45 of the first operation button 4 are housed in the first bearing 11 and supported by the first bearing 11. The first spring 10 is arranged directly below the first shaft 45 in the first bearing 11, and biases the first shaft 45 upward. One end (the lower end) of the first spring 10 is supported by the first bearing 11, and the other end (the upper end) of the first spring 10 abuts against the first shaft 45. The first bearing 11 allows expansion and contraction of the first spring 10 while restricting movement of the first spring 10 in the left-right direction. Note that the first spring 10 need not be arranged directly below the first shaft 45, as long as it is configured to bias the first operation button 4 upward. Specifically, the first spring 10 may be arranged to the right of the first shaft 45 (for example, between the right end of the first operation surface 411 and the first shaft 45) or to the left of the first shaft 45 (for example, between the left end of the first operation surface 411 and the first shaft 45).

In the natural state of the first operation button 4, the first shaft 45 abuts against the upper wall surface of the first bearing 11 due to the biasing force of the first spring 10. Thus, the first shaft 45 is supported by the first bearing 11 via the first spring 10, and the first bearing 11 restricts the upward movement of the first shaft 45. When a downward force is applied to the first shaft 45 by the operation of the first operation button 4, the first shaft 45 moves downward against the biasing force of the first spring 10. As a result, the entirety of the first operation button 4 descends, and the first operation button 4 presses against the first switch 9 via the first protrusion 43.

Furthermore, the first shaft 45 serves as the pivot point of the first operation button 4, and the first operation button 4 rotates about the first shaft 45 relative to the housing 2. In order to effectively generate force for rotating the first shaft 45, it is desirable that the first operation surface 411 be pressed at a position distant from the first shaft 45. Thus, it is conceivable to arrange the first shaft 45 to the right of the first operation surface 411 in order to promote rotation of the first shaft 45. However, in this case, the length of the first operation button 4 in the left-right direction becomes longer, and the space required to install the first operation button 4 becomes larger.

Therefore, in the present embodiment, when the first operation button 4 is viewed from the axial direction of the first shaft 45, the first shaft 45 is arranged so as to be positioned inward from both ends of the first operation surface 411. As a result, the space required to install the first operation button 4 can be reduced as compared to the case in which the first shaft 45 is arranged outward from both ends of the first operation surface 411.

However, in this arrangement, the first operation surface 411 can be pressed on both the left and right sides of the first shaft 45. Thus, for example, if the first shaft 45 has a simple cylindrical shape, the first shaft 45 can rotate freely in both clockwise and counterclockwise directions.

As shown in FIG. 3, when the first switch 9 and first operation button 4 are viewed from the axial direction of the first shaft 45, the first switch 9 is arranged inward from both ends of the first operation surface 411 and to the left of the first shaft 45. In this case, when the first shaft 45 is rotated such that the right end of the first operation surface 411 descends, that is, when the first shaft 45 is rotated clockwise as viewed from the user in the held state, the first operation button 4 rotates clockwise with the position where the left end of the first foundation part 42 abuts against the housing 2 as the pivot point. As a result, the first protrusion 43 of the first operation button 4 moves in the direction approaching the first switch 9. However, since the distance between the pivot point when the first operation button 4 rotates and the point of action at which the first protrusion 43 presses against the first switch 9 is short, rotation of the first operation button 4 does not contribute substantially to the downward movement of the first protrusion 43. Thus, when the first operation button 4 is rotated clockwise until the first protrusion 43 presses against the first switch 9, the right end of the first operation surface 411, which is operated by the fingertip, descends into the opening 271a of the housing 2, which may deteriorate the operability of the first operation button 4. In order to prevent this phenomenon, it is conceivable to increase the thickness of the first keycap part 41 to position the first operation surface 411 away from the upper surface 23 of the housing 2. However, such a design change would increase the vertical length of the controller 1, hindering reductions in size of the controller 1.

On the other hand, when the first shaft 45 is rotated such that the left end of the first operation surface 411 descends, that is, when the first shaft 45 is rotated counterclockwise as viewed from the user in the held state, the first operation button 4 rotates counterclockwise with the position where the first shaft 45 abuts against the first bearing 11 as the pivot point. As a result, the first protrusion 43 of the first operation button 4 moves in the direction approaching the first switch 9. Similar to the right end of the first operation surface 411, when the first operation button 4 is rotated counterclockwise until the first protrusion 43 presses against the first switch 9, the left end of the first operation surface 411 descends into the opening 271a of the housing 2. However, unlike the right end of the first operation surface 411, which is operated with the fingertips, when the left end of the first operation surface 411, which is operated with the portion between the first joint and the third joint of the finger, descends into the opening 271a, there is no discomfort in the operability of the first operation button 4. Therefore, when the first shaft 45 is rotated counterclockwise, the first switch 9 can be pressed by the first operation button 4 without deteriorating the operability of the first operation button 4.

In consideration of this, the first shaft 45 is supported by the first bearing 11 so as to be rotatable in a first rotation direction about an axis and movable in a first linear direction, and is configured to abut against the first bearing 11 when the first shaft 45 attempts to rotate in a second rotation direction opposite to the first rotation direction from the natural state of the first operation button 4, thereby restricting the first operation button 4 from rotating more than a predetermined angle in the second rotation direction. The first switch 9 is pressed by the first operation button 4 when the first operation button 4 is rotated in the first rotation direction by rotation of the first shaft 45, and when the first operation button 4 is moved in the first linear direction by the linear movement of the first shaft 45. As a result, deterioration of the operability of the first operation button 4 can be suppressed even when the rotating part (the first shaft 45 in the present embodiment) of the first operation button 4 is arranged in the inside of both ends of the first operation surface 411.

In the present embodiment, the first rotation direction is counterclockwise as viewed from the user in the held state, the second rotation direction is clockwise as viewed from the user in the held state, and the first linear direction is downward. The first linear direction may be diagonally downward, etc. In this case, when the first operation button 4 is pressed so as to move linearly, the first shaft 45 moves diagonally downward.

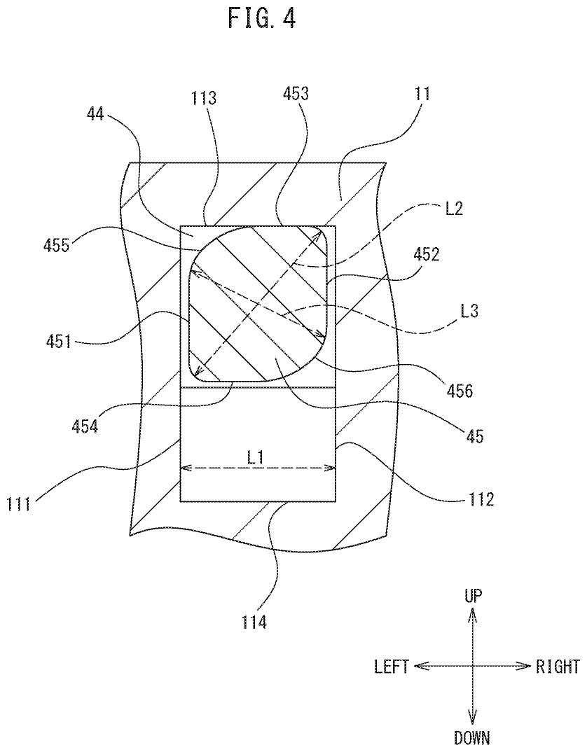

Specific examples of the shape of the first shaft 45 for restricting rotation in one direction will be described below. FIG. 4 is an enlarged view of the first shaft 45 and the first bearing 11 shown in FIG. 3. FIG. 4 shows the first shaft 45 and the first bearing 11 as viewed from the axial direction of the first shaft 45. Note that the first spring 10 is omitted in FIG. 4.

As shown in FIG. 4, the first bearing 11 has a left wall surface 111, a right wall surface 112, an upper wall surface 113, and a lower wall surface 114. The left wall surface 111, the right wall surface 112, the upper wall surface 113, and the lower wall surface 114 define an accommodation space for accommodating the first shaft 45 and the first spring 10.

The left wall surface 111 and the right wall surface 112 extend in the direction away from the upper surface 23 and the first operation surface 411, while the upper wall surface 113 and the lower wall surface 114 extend parallel to the upper surface 23 (horizontal part 233). The left wall surface 111 and the right wall surface 112 face each other and extend parallel to each other. The direction in which the left wall surface 111 and the right wall surface 112 extend is equivalent to the first linear direction in which the first shaft 45 moves linearly, and in the present embodiment, it is the downward direction.

The upper wall surface 113 and the lower wall surface 114 face each other and extend parallel to each other. In the present embodiment, the direction in which the upper wall surface 113 and the lower wall surface 114 extend is the left-right direction. The upper wall surface 113 connects the upper end of the left wall surface 111 and the upper end of the right wall surface 112, and the lower wall surface 114 connects the lower end of the left wall surface 111 and the lower end of the right wall surface 112. The first shaft 45 is arranged between the left wall surface 111 and the right wall surface 112, and the left wall surface 111 and the right wall surface 112 function as sliding surfaces of the first shaft 45 when the first shaft 45 moves in the first linear direction (downward direction in the present embodiment).

In the example shown in FIG. 4, the first shaft 45 has a first straight part 451, a second straight part 452, a third straight part 453, a fourth straight part 454, a first curved part 455, and a second curved part 456. The first straight part 451, the second straight part 452, the first curved part 455, and the second curved part 456 form the outer edge of the first shaft 45. At least one of the third straight part 453 and the fourth straight part 454 may be omitted.

The first straight part 451 faces the left wall surface 111 and extends parallel to the left wall surface 111 in the natural state of the first operation button 4. The second straight part 452 faces the right wall surface 112 and extends parallel to the right wall surface 112 in the natural state of the first operation button 4. The first straight part 451 and the second straight part 452 guide the movement of the first shaft 45 in the first linear direction and smooth the movement of the first shaft 45 in the first linear direction. The first straight part 451 and the second straight part 452 can suppress the exertion of localized forces on the first shaft 45 when the first shaft 45 slides against the left wall surface 111 and the right wall surface 112 due to movement of the first shaft 45 in the first linear direction.

The third straight part 453, in the natural state of the first operation button 4, abuts against the upper wall surface 113 due to the biasing force of the first spring 10 and extends parallel to the upper wall surface 113. The first spring 10 biases the first operation button 4 upward via the first shaft 45. At this time, since the third straight part 453 is in surface contact with the upper wall surface 113 and the left end of the first foundation part 42 abuts against the housing 2, displacement of the position of the first operation button 4 in the natural state can be suppressed. The fourth straight part 454, in the natural state of the first operation button 4, faces the lower wall surface 114 and extends parallel to the lower wall surface 114.

The first curved part 455 extends from the first straight part 451 and connects the first straight part 451 and the third straight part 453. The first curved part 455 extends in a direction that includes the direction approaching the second straight part 452 and the direction approaching the first operation surface 411 when the first operation button 4 and the first bearing 11 are viewed from the axial direction of the first shaft 45. The second curved part 456 extends from the second straight part 452 and connects the second straight part 452 and the fourth straight part 454. The second curved part 456 extends in a direction that includes the direction approaching the first straight part 451 and the direction away from the first operation surface 411 when the first operation button 4 and the first bearing 11 are viewed from the axial direction of the first shaft 45.

In the present embodiment, the first shaft 45 is configured such that, when the first shaft 45 and the first bearing 11 are viewed from the axial direction of the first shaft 45, the linear distance connecting two predetermined points on the outer edge of the first shaft 45 is greater than the distance between the left wall surface 111 and the right wall surface 112. As a result, when the first shaft 45 is rotated, it can reliably abut against the first bearing 11, thereby preventing rotation of the first shaft 45.

In the example shown in FIG. 4, among the linear distances connecting any two points on the outer edge of the first shaft 45, linear distance L2 connecting the upper right point of the first shaft 45 and the lower left point of the first shaft 45 is greatest, and this distance L2 is greater than distance L1 between the left wall surface 111 and the right wall surface 112. Thus, since the upper right point of the first shaft 45 abuts against the right wall surface 112 and the lower left point of the first shaft 45 abuts against the left wall surface 111, rotation of the first shaft 45 is restricted. Note that the linear distance connecting the lower end of the first straight part 451 and the upper end of the second straight part 452 may be greater than the distance L1 between the left wall surface 111 and the right wall surface 112.

When the portion of the first operation surface 411 to the right of the first shaft 45 is pushed down by the user, the first shaft 45 attempts to rotate clockwise. When the first shaft 45 rotates clockwise, the upper right point of the first shaft 45 is closest to the right wall surface 112, and the lower left point of the first shaft 45 is closest to the left wall surface 111. Therefore, the linear distance L2 connecting the point on the outer edge of the first shaft 45 that is closest to the left wall surface 111 when the first shaft 45 rotates clockwise, and the point on the outer edge of the first shaft 45 that is closest to the right wall surface 112 when the first shaft 45 rotates clockwise, is greater than the distance L1 between the left wall surface 111 and the right wall surface 112. Thus, in the example in FIG. 4, when the first shaft 45 rotates clockwise, it abuts against the first bearing 11, whereby clockwise rotation of the first shaft 45 is restricted.

On the other hand, the linear distance (for example, distance L3) connecting a first point on the first curved part 455 and a second point on the second curved part 456 is less than the distance L1 between the left wall surface 111 and the right wall surface 112. In the example in FIG. 4, in the natural state of the first operation button 4, the point on the first curved part 455 closest to the left wall surface 111 is selected as the first point, and in the natural state of the first operation button 4, the point on the second curved part 456 closest to the right wall surface 112 is selected as the second point.

When the user depresses the portion of the first operation surface 411 to the left of the first shaft 45, the first shaft 45 attempts to rotate counterclockwise. Specifically, when the user depresses the portion of the first operation surface 411 to the left of the first switch 9, only counterclockwise rotation occurs as the operation of the first shaft 45, and when the user depresses the portion of the first operation surface 411 between the first switch 9 and the first shaft 45, the first shaft 45 moves in the first linear direction and rotates counterclockwise. When the first shaft 45 rotates counterclockwise, the first curved part 455 is closest to the left wall surface 111, and the second curved part 456 is closest to the right wall surface 112. Therefore, the linear distance (for example, the distance L3) connecting the point on the outer edge of the first shaft 45 that is closest to the left wall surface 111 when the first shaft 45 is rotated counterclockwise, and the point on the outer edge of the first shaft 45 that is closest to the right wall surface 112 when the first shaft 45 is rotated counterclockwise, is less than the distance L1 between the left wall surface 111 and the right wall surface 112. Thus, in the example of FIG. 4, the first shaft 45 is rotated counterclockwise without abutting against the first bearing 11. Note that the distance L3 may be equal to the distance L1. In this case, the first curved part 455 and the second curved part 456 contact the left wall surface 111 and the right wall surface 112, respectively, while the first shaft 45 is rotated counterclockwise.

Furthermore, in the example shown in FIG. 4, the first curved part 455 and the second curved part 456 are arcs when viewed from the axial direction of the first shaft 45. This prevents the first shaft 45 from catching on the wall surface of the first bearing 11, enabling smoother counterclockwise rotation of the first shaft 45.

Furthermore, in the example shown in FIG. 4, a gap is provided between the first shaft 45 and the first bearing 11 to account for dimensional variations in the first shaft 45 and the first bearing 11. Specifically, in the natural state of the first operation button 4, a gap is provided between the first straight part 451 and the left wall surface 111, and a gap is provided between the second straight part 452 and the right wall surface 112. As a result, the first shaft 45 can rotate clockwise by the amount of this gap. However, the angle by which the first shaft 45 can rotate clockwise is less than or equal to a predetermined angle, and this predetermined angle is less than the angle by which the first shaft 45 can rotate counterclockwise. Alternatively, these gaps may be removed, and in the natural state of the first operation button 4, the first straight part 451 may contact the left wall surface 111, and the second straight part 452 may contact the right wall surface 112. In this case, the angle by which the first shaft 45 can rotate clockwise becomes zero.

Furthermore, in the natural state of the first operation button 4, instead of the first shaft 45 abutting against the upper wall surface 113 of the first bearing 11, the first foundation part 42 of the first operation button 4 may abut against the housing 2. In this case, the upper wall surface 113 of the first bearing 11 may be omitted.

Furthermore, in the present embodiment, since the first shaft 45 is arranged so as to be positioned inward from both ends of the first operation surface 411, the third operation button 6 can be arranged adjacent to the first operation button 4 in the left-right direction. As shown in FIG. 2, when the third operation button 6 is arranged to the right of the first operation button 4, the user tends to operate the right end of the first operation surface 411 of the first operation button 4 that is closer to the third operation button 6 when performing continuous button operations from the third operation button 6 to the first operation button 4. To address this, in the present embodiment, clockwise rotation of the first shaft 45 when the right end of the first operation button 4 is pressed is restricted. Thus, deterioration of the operability of the first operation button 4 during such continuous button operations can be suppressed, and continuous button operations from the third operation button 6 to the first operation button 4 can be made smoother.

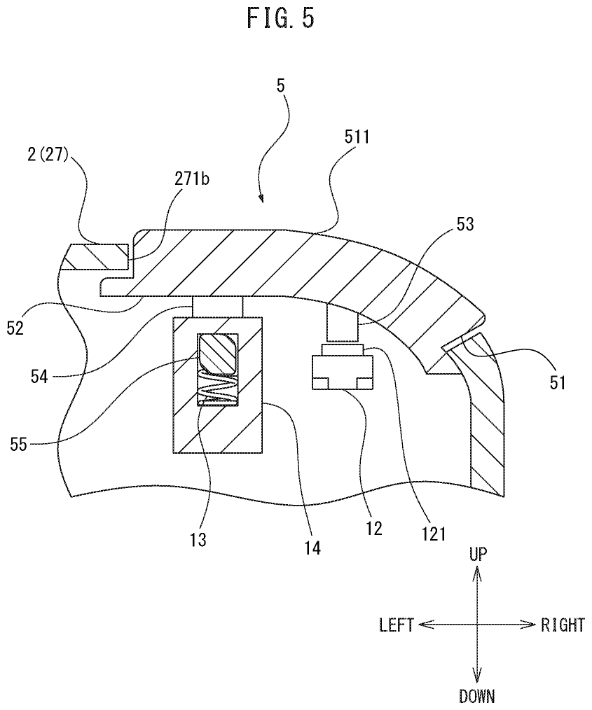

FIG. 5 is a partial cross-sectional view of the controller 1 taken along line B-B of FIG. 2. As shown in FIG. 5, the controller 1 includes a second switch 12 and a second spring 13 as internal components. The second switch 12 and the second spring 13 are arranged in an area closer to the right surface 26 than to the left surface 25, and the second switch 12 is arranged to the right of the second spring 13.

The second switch 12 is arranged directly below the second operation button 5 in the interior space of the housing 2 and is pressed by the second operation button 5. The first switch 9 and the second switch 12 have the same shape and are arranged in symmetrical positions with respect to the left-right center line CL of the controller 1. The first switch 9 and the second switch 12 are mounted on, for example, a circuit board housed in the housing 2. The first switch 9 and the second switch 12 are, for example, tactile switches. Note that the first switch 9 and the second switch 12 may have shapes different from each other.

The second spring 13 is arranged directly below the second operation button 5 in the interior space of the housing 2, and biases the second operation button 5 upward. The first spring 10 and the second spring 13 have the same shape and are arranged in symmetrical positions with respect to the left-right center line CL of the controller 1. The first spring 10 and the second spring 13 are, for example, compression coil springs. However, the first spring 10 and the second spring 13 may have shapes different from each other. Furthermore, the first operation button 4 and the second operation button 5 may be biased upward by other elastic bodies or other structures instead of or in addition to the springs. For example, when the first switch 9 and the second switch 12 are tactile switches, the first operation button 4 and the second operation button 5 may be biased upward by the dome portion, and when the first switch 9 and the second switch 12 are rubber switches, they may be biased upward by the key rubber.

The first operation button 4 and the second operation button 5 are arranged in symmetrical positions with respect to the left-right center line CL of the controller 1 and have shapes symmetrical with respect to the left-right center line CL. Specifically, the second operation button 5, similar to the first operation button 4, includes a second keycap part 51, a second foundation part 52, a second protrusion 53, a second shaft base 54, and a second shaft 55. The second keycap part 51, the second foundation part 52, the second protrusion 53, the second shaft base 54, and the second shaft 55 are integrally molded by injection molding, die casting, or the like. The second keycap part 51, similar to the first keycap part 41, has a second operation surface 511 that is exposed from the opening 271b of the housing 2.

The controller 1 includes a second bearing 14 provided in the interior of the housing 2. The second bearing 14 houses a second spring 13 and a second shaft 55. The second bearing 14 is arranged in an area closer to the right surface 26 than to the left surface 25, and is arranged to the left of the second switch 12. The first bearing 11 and the second bearing 14 have the same shape and are arranged in symmetrical positions with respect to the left-right center line CL of the controller 1.

The second switch 12, the second spring 13, the second bearing 14, and the second operation button 5 have the same characteristics as the first switch 9, the first spring 10, the first bearing 11, and the first operation button 4, respectively, and function in the same manner as the first switch 9, the first spring 10, the first bearing 11, and the first operation button 4. For example, when the second operation button 5 is viewed from the axial direction of the second shaft 55, the second shaft 55 is arranged so as to be positioned inward from both ends of the second operation surface 511.

Furthermore, the second shaft 55 is supported by the second bearing 14 so as to be rotatable in the second rotation direction and movable in the first linear direction, and is configured to abut against the second bearing 14 when the second shaft 55 attempts to rotate in the first rotation direction, opposite to the second rotation direction, from the natural state in which the second operation button 5 is not operated, thereby restricting the second operation button 5 from rotating by more than a predetermined angle in the first rotation direction. As described above, in the present embodiment, the first rotation direction is counterclockwise as viewed from the user in the held state, the second rotation direction is clockwise as viewed from the user in the held state, and the first linear direction is downward. The second switch 12 is pressed by the second operation button 5 when the second operation button 5 is rotated in the second rotation direction by rotation of the second shaft 55, and when the second operation button 5 is moved in the first linear direction by the linear movement of the second shaft 55. Due to these characteristics, the same effects as the first operation button 4 are brought about by the second operation button 5.

### Second Embodiment

The controller according to the second embodiment is basically identical to the controller according to the first embodiment, except for the points described below. Thus, the second embodiment of the present disclosure will be described below focusing on the differences from the first embodiment.

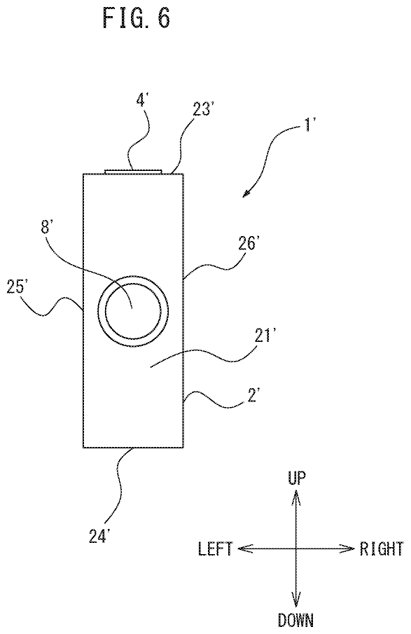

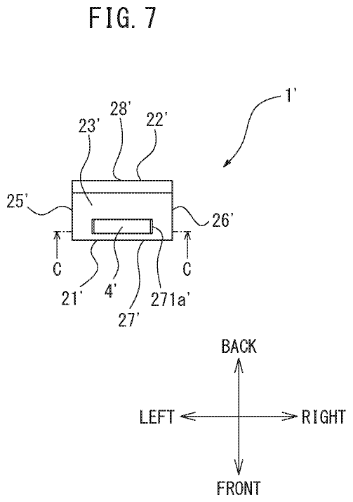

FIG. 6 is a front view of a controller 1′ according to the second embodiment of the present disclosure, and FIG. 7 is a top view of the controller 1′ according to the second embodiment of the present disclosure. The controller 1′ has a substantially rectangular parallelepiped shape and is held by the user. The user holds the controller 1′ in the orientation shown in FIG. 6, and FIG. 6 shows the controller 1′ on the side facing the user.

Similar to the first embodiment, the housing 2′ of the controller 1′ has a primary surface 21′, a back surface 22′, and a side surface, and the side surface has an upper surface 23′, a lower surface 24′, a left surface 25′, and a right surface 26′. The housing 2′ includes a first housing 27′ and a second housing 28′, and is formed by combining the first housing 27′ and the second housing 28′. In the second embodiment, the length of the housing 2′ in the up-down direction is greater than the length of the housing 2′ in the left-right direction, and the controller 1′ has a vertically elongated shape.

In the second embodiment, the controller 1′ includes a first operation button 4′ as an operation member provided at the upper surface 23′ of the housing 2′. The first operation button 4′ is arranged in the central area of the controller 1′ in the left-right direction. For example, the controller 1′ is held by one of the hands (left or right) of the user, and the first operation button 4′ is operated by a finger (index or middle finger) of one of the hands of the user.

Furthermore, the controller 1′ includes a direction input part 8′ as an operation member provided on the primary surface 21′ of the housing 2′. The direction input part 8′ is operated by the user when the user inputs a direction, and is, for example, an analog stick. Note that the direction input part 8′ may be a directional pad or the like. The controller 1′ may include other operation members (for example, a group of buttons, another stick member, a home button, etc.) instead of or in addition to the direction input part 8′ as an operation member provided on the primary surface 21′ of the housing 2′.

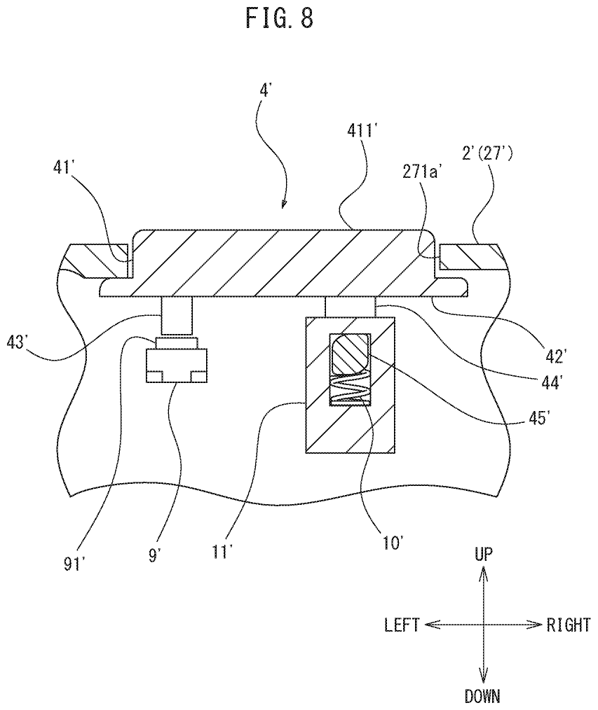

FIG. 8 is a partial cross-sectional view of the controller 1′ taken along line C-C of FIG. 7. The controller 1′ includes a first switch 9′ and a first spring 10′ as internal components. The first switch 9′ is arranged in the interior space of the housing 2′ directly below the first operation button 4′ and is pressed by the first operation button 4′. The first switch 9′ is mounted on, for example, a circuit board housed in the housing 2′. The first switch 9′ is, for example, a tactile switch.

The first spring 10′ is arranged in the interior space of the housing 2′ directly below the first operation button 4′, and biases the first operation button 4′ upward. The first spring 10′ is, for example, a compression coil spring. Alternatively, the first operation button 4′ may be biased upward by other elastic bodies or other structures instead of or in addition to the spring. For example, when the first switch 9′ is a tactile switch, the first operation button 4′ may be biased upward by the dome portion, and when the first switch 9′ is a rubber switch, it may be biased upward by the key rubber.

As shown in FIG. 8, the first operation button 4′ has a first keycap part 41′, a first foundation part 42′, a first protrusion 43′, a first shaft base part 44′, and a first shaft 45′. The first keycap part 41′, the first foundation part 42′, the first protrusion 43′, the first shaft base part 44′, and the first shaft 45′ are integrally molded by injection molding, die casting, or the like.

The controller 1′ includes a first bearing 11′ provided in the interior of the housing 2′. The first bearing 11′ houses the first spring 10′ and the first shaft 45′. In the present embodiment, it is assumed that the controller 1′ is held by the left hand of the user. Thus, the first bearing 11′ is positioned to the right of the first switch 9′ such that the first switch 9′ is positioned to the left of the first shaft 45′.

The first switch 9′, the first spring 10′, and the first bearing 11′ have the same characteristics as the first switch 9, the first spring 10, and the first bearing 11 of the first embodiment, and function in the same manner as the first switch 9, the first spring 10, and the first bearing 11. The first operation button 4′ has the same characteristics as the first operation button 4 of the first embodiment, except that the first keycap part 41′ and the first foundation part 42′ do not have curved parts along the curved upper surface, and function in the same manner as the first operation button 4. For example, when the first operation button 4′ is viewed from the axial direction of the first shaft 45′, the first shaft 45′ is arranged so as to be positioned inward from both ends of the first operation surface 411′.

Furthermore, the first shaft 45′ is supported by the first bearing 11′ so as to be rotatable in the first rotation direction and movable in the first linear direction, and is configured to abut against the first bearing 11′ when the first shaft 45′ attempts to rotate in the second rotation direction opposite to the first rotation direction from the natural state in which the first operation button 4′ is not operated, thereby restricting the first operation button 4′ from rotating more than a predetermined angle in the second rotation direction. In the controller 1′, the first rotation direction is counterclockwise as viewed from the user in the held state, the second rotation direction is clockwise as viewed from the user in the held state, and the first linear direction is the downward direction. The first switch 9′ is pressed by the first operation button 4′ when the first operation button 4′ is rotated in the first rotation direction by rotation of the first shaft 45′, and when the first operation button 4′ is moved in the first linear direction by the linear movement of the first shaft 45′. According to these characteristics, the same effects as the first operation button 4 of the first embodiment are brought about by the first operation button 4′.

Note that the housing 2′ may have a horizontally elongated shape. Furthermore, an operation member such as a direction input part may be provided on the primary surface 21′ of the housing 2′. The upper surface 23′ of the housing 2′ may have an upper left corner and a horizontal part, and the first operation button 4′ may have the same shape as the first operation button 4 of the first embodiment. Furthermore, if it is assumed that the controller 1′ is held by the right hand of the user, the first switch 9′ may be arranged to the right of the first shaft 45′, and the first shaft 45′ may have the same shape as the second shaft 55′ of the second operation button 5 of the first embodiment. Accordingly, the first rotation direction in which rotation of the first shaft 45′ is permitted may be clockwise when viewed from the user in the held state, and the second rotation direction in which rotation of the first shaft 45′ is restricted may be counterclockwise when viewed from the user in the held state.

### Other Embodiments

Though preferred embodiments of the present disclosure have been described above, the present disclosure is not limited to these embodiments, and various changes and modifications can be made. For example, the housings 2, 2′ may include equal to or greater than three members (for example, a primary surface member, a back surface member, and a connection member, etc.) and be formed by combining these members.

Furthermore, in the first embodiment, in the same manner as the second embodiment, the upper surface 23 of the housing 2 may have only a horizontal part, and the first operation button 4 may have the same shape as the first operation button 4′. In this case, the second operation button 5, which has a shape symmetrical to the first operation button 4, can also be likewise modified. Furthermore, the third operation button 6 and the fourth operation button 7 may be omitted in the controller 1.

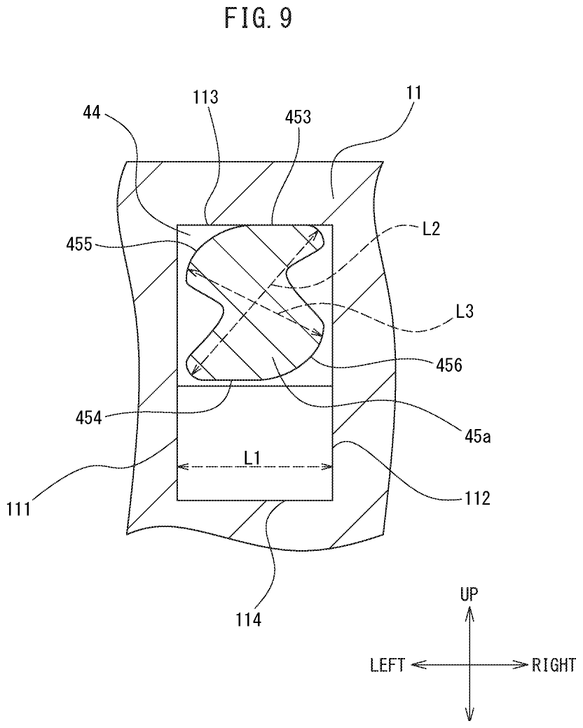

Furthermore, the first shaft 45 of the first operation button 4 may have other shapes which are configured to restrict rotation of the first shaft 45 in one direction. For example, as shown in the modification example of FIG. 9, the first straight part 451 and the second straight part 452 may be omitted from the first shaft 45a, the first curved part 455 and the fourth straight part 454 may be connected by a curved part, and the second curved part 456 and the third straight part 453 may be connected by a curved part. In this case, clockwise rotation of the first shaft 45a is restricted by the linear distance L2 connecting the upper right point of the first shaft 45a and the lower left point of the first shaft 45a. Alternatively, the first straight part 451 and the second straight part 452 may be omitted, and the first shaft 45 may have an elliptical shape in which the linear distance connecting two predetermined points on the outer edge of the first shaft 45 is greater than the distance between the left wall surface 111 and the right wall surface 112. Note that the shapes of the second shaft 55 of the second operation button 5 and the first shaft 45′ of the first operation button 4′ can also be changed in a similar manner.

Furthermore, the first operation button 4 may be configured such that the axis of the first shaft 45 extends in directions other than the front-to-back direction. For example, the first operation button 4 may be configured such that the axis of the first shaft 45 extends in the left-to-right direction. Note that the second operation button 5 and the first operation button 4′ can also be modified in a similar manner.

1. A controller comprising:
a housing which has an opening;
a first bearing which is provided in an interior of the housing;
a first operation button which has a first operation surface exposed from the opening, and a first shaft which is supported by the first bearing so as to be rotatable in a first rotation direction about an axis and movable in a first linear direction; and
a first switch which is pressed by the first operation button when the first operation button is rotated in the first rotation direction by rotation of the first shaft, and when the first operation button is moved in the first linear direction by linear movement of the first shaft, wherein
when the first operation button is viewed from an axial direction of the first shaft, the first shaft is arranged so as to be positioned inward from both ends of the first operation surface, and
the first shaft is configured to abut against the first bearing when the first shaft attempts to rotate in a second rotation direction opposite to the first rotation direction from a natural state in which the first operation button is not operated, thereby restricting the first operation button from rotating more than a predetermined angle in the second rotation direction.

2. The controller according to claim 1, wherein the first bearing has two wall surfaces which extend in a direction away from the first operation surface and face each other, and
when the first shaft and the first bearing are viewed from the axial direction, a linear distance connecting two predetermined points on an outer edge of the first shaft is greater than a distance between the two wall surfaces.

3. The controller according to claim 1, wherein the first bearing has two wall surfaces which extend in a direction away from the first operation surface and face each other, and
the first shaft has a first straight part which extends parallel to one of the two wall surfaces in the natural state, and a second straight part which extends parallel to the other of the two wall surfaces in the natural state.

4. The controller according to claim 3, wherein the first shaft has a first curved part which extends from the first straight part, and a second curved part which extends from the second straight part,
the first curved part extends in a direction including a direction which approaches the second straight part and a direction which approaches the first operation surface when the first operation button and the first bearing are viewed from the axial direction, and the second curved part extends in a direction including a direction which approaches the first straight part and a direction away from the first operation surface when the first operation button and the first bearing are viewed from the axial direction, and
a linear distance connecting a first point on the first curved part and a second point on the second curved part is equal to or less than a distance between the two wall surfaces.

5. The controller according to claim 4, wherein the first curved part and the second curved part are arcs when viewed from the axial direction.

6. The controller according to claim 1, further comprising:
a second bearing which is provided in an interior of the housing;
a second operation button which has a second operation surface exposed from the opening, and a second shaft which is supported by the second bearing so as to be rotatable in the second rotation direction and movable in the first linear direction; and
a second switch which is pressed by the second operation button when the second operation button is rotated in the second rotation direction by rotation of the second shaft, and when the second operation button is moved in the first linear direction by linear movement of the second shaft, wherein
when the second operation button is viewed in an axial direction of the second shaft, the second shaft is arranged so as to be positioned inward from both ends of the second operation surface,
the second shaft is configured to abut against the second bearing when the second shaft attempts to rotate in the first rotation direction from a natural state in which the second operation button is not operated, thereby restricting the second operation button from rotating more than the predetermined angle in the first rotation direction,
the housing has:
a primary surface where a direction input part operated by a user is provided;
an upper surface positioned upward as viewed from the user in a state in which the housing is held by the user such that the primary surface faces the user;
a left surface positioned leftward as viewed from the user in the state; and
a right surface positioned on a side opposite the left surface;
the first operation button is arranged in an area at the upper surface which is closer to the left surface than to the right surface and to which a left index finger or left middle finger of the user extends when the housing is held by the user,
the second operation button is arranged in an area at the upper surface which is closer to the right surface than the left surface and to which a right index finger or right middle finger of the user extends when the housing is held by the user, and
the first rotation direction is counterclockwise as viewed from the user in the state, and the second rotation direction is clockwise as viewed from the user in the state.

7. The controller according to claim 6, further comprising:
a third operation button arranged in an area at the upper surface which is more to the right surface side than the first operation button and to which a left index finger or left middle finger of the user extends when the housing is held by the user; and
a fourth operation button arranged in an area at the upper surface which is more to the left surface side than the second operation button and to which a right index finger or right middle finger of the user extends when the housing is held by the user.
